(19) United States
(12) Patent Application Publication
(10) Pub. No.: US 2024/0125161 A1
(43) Pub. Date: Apr. 18, 2024

(54) METHOD AND SYSTEM FOR MOTOR-DRIVEN ASSISTANCE OF THE MOVEMENT OF A VEHICLE DOOR

(71) Applicant: Conti Temic microelectronic GmbH, Ingolstadt (DE)

(72) Inventors: Martin Wölfle, Saulgau (DE); Kevin Schmitz, Heiligenberg (DE)

(73) Assignee: Conti Temic microelectronic GmbH, Ingolstadt (DE)

(21) Appl. No.: 18/275,926

(22) PCT Filed: Jan. 19, 2022
(86) PCT No.: PCT/DE2022/200005

§ 371 Date: Aug. 4, 2023

(30) Foreign Application Priority Data
Feb. 4, 2021 (DE) 10 2021 201 049.0

(51) Int. Cl. E05F 15/611

(52) U.S. Cl. CPC E05F 15/611; E05Y 2400/31; E05Y 2400/44; E05Y 2800/113; E05Y 2900/531

(57) ABSTRACT

Method and system for motor-driven assistance of the movement of a vehicle door, wherein the vehicle door is driven by means of an electric motor, which is controlled by a control unit, depending on a force exerted on the vehicle door by an operator, in a manner assisting this force or exceeding the force, comprising the steps:
the voltage induced in the electric motor due to the force exerted on the vehicle door by the operator is detected and transmitted to the control unit,
this electrical voltage or a signal derived from it is compared with prescribed threshold values in the control unit during a defined, adjustable time interval, and
the motor is driven by the control unit, depending on whether the threshold values are exceeded or undershot, in a manner merely assisting the force exerted on the vehicle door by the operator or exceeding the force.

A number of systems that enable automatic and assisted opening or closing of a vehicle door or tailgate or another movable vehicle body part, referred to simply as vehicle door in the text which follows, are already available on the market. Complex sensor-based systems are usually used here in order to identify operation of the vehicle door. One example would be the use of acceleration sensors, force sensors and/or yaw rate sensors in order to be able to identify active operation of the door by a person and distinguish this from environmental influences.

In these systems, an electric motor creates the possibility of applying an assisting force to the vehicle door. This is intended to make it easier for the user to perform the movement by hand. Therefore, the user only has to overcome a freely adjustable portion of a braking device.

DE 10 2007 062 472 A1 discloses a method for motor-driven assistance of the movement of a vehicle door, wherein the vehicle door is driven by means of an electric motor, which is controlled by a control unit, depending on a force exerted on the vehicle door by an operator, in a manner assisting this force or exceeding the force. In the process, the force exerted on the vehicle door by the operator is detected and transmitted to the control unit. The motor is driven by the control unit, depending on whether threshold values are exceeded or undershot, in a manner merely assisting the force exerted on the vehicle door by the operator or exceeding the force. Complicated optical and/or haptic sensors are used here to determine the force exerted on the vehicle door by the operator in order to take into account influences of the door property depending thereon based on the location of the action of force. However, complex sensors are required to fulfil this task.

DE 10 2018 121 346 A1 discloses a method in which, in a first variant, a motion sensorassigned to a vehicle flap and/or to the drive arrangement is provided, via the sensor signals of which a predetermined, manual operating action is detected. As an alternative or in addition, an electric drive current assigned to the drive arrangement is detected. This electric drive current may be the drive current flowing through a drive motor of the drive arrangement. Such detection of the drive current basically allows sensor-free and therefore cost-effective detection of the predetermined operating action. Further as an alternative or in addition, the operating action can also be detected by means of the control arrangement based on a drive voltage assigned to the drive arrangement, in particular a generator voltage. Sensor-free and therefore cost-effective detection of the predetermined operating action is possible in this way too. However, the determined current values are not specified in any detail. Moreover, they are not suitable for including, for example, flap properties, such as their rigidity for example, in a motor-assisted movement of the vehicle flap.

The object of the invention is to create a method that is as simple as possible in order to identify operation of a vehicle door and, if necessary, to assist the movement by motor.

The object is achieved by a method as claimed in claim 1. Advantageous developments are specified in the dependent claims.

Accordingly, in a method for motor-driven assistance of the movement of a vehicle door, wherein the vehicle door is driven by means of an electric motor, which is controlled by a control unit, depending on a force exerted on the vehicle door by an operator, in a manner assisting this force or exceeding the force, the voltage induced in the electric motor due to the force exerted on the vehicle door by the operator is detected and transmitted to the control unit, this electrical voltage or a signal derived from it is compared with prescribed threshold values in the control unit over a defined, adjustable time interval, and the motor is driven by the control unit, depending on whether the threshold values are exceeded or undershot, in a manner merely assisting the force exerted on the vehicle door by the operator or exceeding the force.

The method according to the invention therefore consists in drawing conclusions about the external force from an initial, first, externally forced motor movement, measurable by a voltage induced in a motor winding, and correspondingly controlling the motor operating the vehicle door using a control unit.

In one embodiment of the method according to the invention, a movement of the vehicle door is not assisted by motor when a first threshold is undershot, the vehicle door is moved merely with a motor-driven force assisting the force exerted on the vehicle door by the operator when the first threshold is exceeded and a second threshold is still undershot, the vehicle door is automatically moved by motor when the second threshold is exceeded and a third threshold is still undershot, and the vehicle door is not moved or is moved only in a braked manner when the third threshold is exceeded.

The process of moving the vehicle door can be a closing or an opening process here.

A movement is identified as soon as the induced voltage exceeds a defined threshold value. If the system contains a brake, as in most cases, this already has to be overridden for this purpose. Therefore, a certain amount of basic force already has to be applied to the door. The profile of the induced voltage within a defined time window is then characterized.

The profile of the induced voltage on the motor is observed for a certain adjustable time and then characterized. Either the voltage difference after a fixed time or the integrated voltage signal can be used for this purpose. If the result lies below a certain threshold value, there is merely a brief fault in the system. A user would continuously apply or continuously increase force. Therefore, in this situation, there is no motor control or motor-driven assistance of the door movement.

If the result lies above the minimum threshold but still below a threshold that identifies rapid pushing, the power assistance control in the control unit is activated.

If the result lies above the threshold for rapid pushing but still below an impact identification threshold, an automatic movement of the door can be initiated. The user has pushed the door quickly here and expects the door to continue closing. This is ensured by starting the automatic movement with anti-trap protection.

However, if the result lies above the threshold for identifying an impact or strong external influence (e.g. gust of wind), the vehicle door is not activated and can even be additionally braked by motor in order to hold the door in position and avoid endangering anyone as far as possible.

The invention is explained in more detail below on the basis of an exemplary embodiment with the aid of figures, in which:

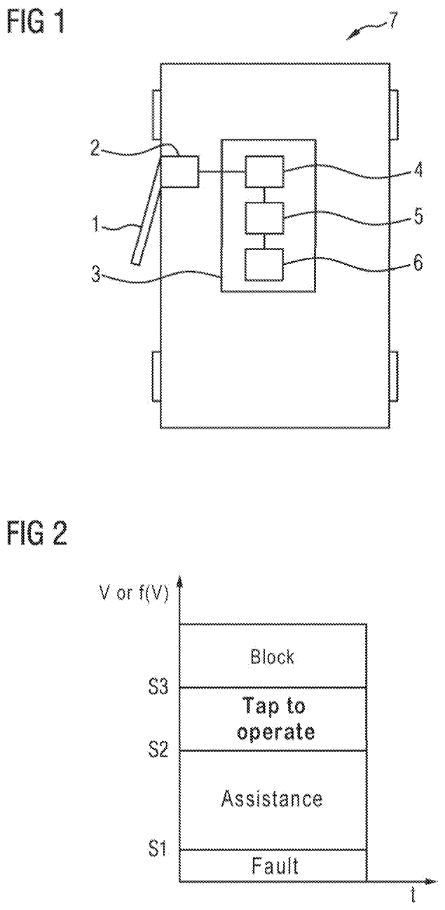

FIG. 1 shows a schematic illustration of a vehicle with a motor-operated door movement system, and

FIG. 2 shows a possible voltage characterization diagram with different evaluation thresholds for an induced voltage or a signal derived from it.

FIG. 1 schematically shows a vehicle 7 with an indicated vehicle door 1. Here, the term “vehicle door” is intended to mean any form of body part that is movably attached to the overall vehicle body and can be opened or closed, that is to say actual doors or else engine hoods or tailgates for example.

The vehicle door 1 is intended to be able to be motor-operated by means of a motor 2, the motor 2 being designed as an electric motor and being able to be controlled by a control unit 3 in order to operate the vehicle door 1 by motor. For this purpose, the control unit 3 has a control loop 4, which ensures that the movement of the vehicle door 1 takes place continuously at the desired or calculated speed, a data-processing device 5, which transmits input signals to the control loop 4, and a detection device 6, which can be designed, for example, with sensors and transmits corresponding signals to the data-processing device 5.

In the control unit 3, it is identified in a manner according to the invention that the motor 2 was likewise set in motion by moving the vehicle door 1, whereupon the data-processing device 5 observes the voltage induced in the motor 2 as a result and, if necessary, integrates it or forms a running difference over a specific time period and, depending on the magnitude of this determined signal, which is compared with thresholds S1 to S3, supplies signals to the control loop 4 and via this to the motor 2 in order to, if necessary, open the vehicle door 1 automatically, opens in a manner merely assisting the force applied by the user or else omits or even prevents operation by motor.

FIG. 2 shows the voltage V induced in the motor 2 or, as an alternative to this, a function of this voltage V, which can represent, for example, the integral over the induced voltage V or else a difference over a specific period of time, as a function of time. Three thresholds S1 to S3 are drawn in the diagram, the intention being for a decision as to whether the vehicle door 1 should be opened with assistance by the motor 2 to be made on the basis of the thresholds being exceeded or undershot.

If the first threshold S1 is undershot, it is assumed that there is merely a fault and the motor 2 may not be controlled. If the voltage signal lies between the first threshold S1 and the second threshold S2, the motor 2 is controlled such that it merely assists the force applied by the operator, while the door is automatically opened by motor when the second threshold S2 is exceeded and the third threshold S3 is still undershot, that is to say the force applied by the user is exceeded. If the third threshold S3 is exceeded, it is assumed that there was an impact or another powerful external event, for example a gust of wind, that moved the vehicle door, and further movement of the vehicle door 1 is not assisted by motor. If necessary, a movement of the vehicle door 1 can even be braked by motor in order to hold the door in position and not endanger anyone as far as possible.

1. A method for motor-driven assistance of movement of a vehicle door,
wherein the vehicle door is driven by an electric motor, which is controlled by a control unit, depending on a force exerted on the vehicle door by an operator, in a manner assisting the force or exceeding the force, comprising:
detecting and transmitting to the control unit voltage induced in the electric motor due to the force exerted on the vehicle door by the operator,
comparing with prescribed threshold values in the control unit during a defined, adjustable time interval the induced voltage or a signal derived from the induced voltage, and
driving the motor by the control unit, depending on whether the threshold values are exceeded or undershot, in a manner merely assisting the force exerted on the vehicle door by the operator or exceeding the force.

2. The method as claimed in claim 1, wherein movement of the vehicle door is not assisted by the motor when a first threshold is undershot, the vehicle door is moved merely with a motor-driven force assisting the force exerted on the vehicle door by the operator when the first threshold is exceeded and a second threshold is still undershot, the vehicle door is automatically moved by motor when the second threshold is exceeded and a third threshold is still undershot, and the vehicle door is not moved or is moved only in a braked manner when the third threshold is exceeded.

3. The method as claimed in claim 1, wherein moving of the vehicle door is a closing or an opening process.

4. The method as claimed in claim 1, wherein the signal derived from the induced voltage is voltage difference over a prescribed time.

5. The method as claimed in claim 1, wherein the signal derived from the induced voltage is voltage integrated over a prescribed time.

6. The method as claimed in claim 2, wherein moving of the vehicle door is a closing or an opening process.

7. The method as claimed in claim 2, wherein the signal derived from the induced voltage is voltage difference over a prescribed time.

8. The method as claimed in claim 3, wherein the signal derived from the induced voltage is voltage difference over a prescribed time.

9. The method as claimed in claim 2, wherein the signal derived from the induced voltage is voltage integrated over a prescribed time.

10. The method as claimed in claim 3, wherein the signal derived from the induced voltage is voltage integrated over a prescribed time.

11. The method as claimed in claim 4, wherein the signal derived from the induced voltage is voltage integrated over the prescribed time.

12. The method as claimed in claim 4, wherein the signal derived from the induced voltage is voltage integrated over another prescribed time.

13. A motor-operated vehicle door movement system configured to execute the method as claimed in claim 1.

14. The system as claimed in claim 13, wherein the moving of the vehicle door is a closing or an opening process.

15. The system as claimed in claim 13, wherein the signal derived from the induced voltage is voltage difference over a prescribed time.

16. The system as claimed in claim 13, wherein the signal derived from the induced voltage is voltage integrated over a prescribed time.

17. The system as claimed in claim 13, wherein movement of the vehicle door is not assisted by motor when a first threshold is undershot, the vehicle door is moved merely with a motor-driven force assisting the force exerted on the vehicle door by the operator when the first threshold is exceeded and a second threshold is still undershot, the vehicle door is automatically moved by motor when the second threshold is exceeded and a third threshold is still undershot, and the vehicle door is not moved or is moved only in a braked manner when the third threshold is exceeded.

18. The system as claimed in claim 17, wherein the moving of the vehicle door is a closing or an opening process.

19. The system as claimed in claim 17, wherein the signal derived from the induced voltage is voltage difference over a prescribed time.

20. The system as claimed in claim 17, wherein the signal derived from the induced voltage is voltage integrated over a prescribed time.
